(19) United States
(12) Patent Application Publication
(10) Pub. No.: US 2021/0056449 A1
(43) Pub. Date: Feb. 25, 2021

(54) CAUSAL RELATION ESTIMATING DEVICE, CAUSAL RELATION ESTIMATING METHOD, AND CAUSAL RELATION ESTIMATING PROGRAM

(71) Applicant: NEC CORPORATION, Tokyo (JP)

(72) Inventors: Yasuhiro SOGAWA, Tokyo (JP); Akihiro YABE, Tokyo (JP)

(73) Assignee: NEC CORPORATION, tokyo (JP)

(21) Appl. No.: 17/044,530

(22) PCT Filed: Jul. 25, 2018
(86) PCT No.: PCT/JP2018/027920

§ 371 Date: Oct. 1, 2020

Related U.S. Application Data
(60) Provisional application No. 62/672,088, filed on May 16, 2018.

(51) Int. Cl. G06N 5/04; G06N 5/02

(52) U.S. Cl. CPC G06N 5/046; G06N 5/022

(57) ABSTRACT

A query specification unit 81 specifies a query as a combination of a variable, on which an intervention operation is performed for a causal relation, and a value of the variable. An intervention data generating unit 82 generates intervention data including a value of a target variable, acquired with an intervention operation based on the query, and the query. A causal relation updating unit 83 updates the causal relation using the generated intervention data. On this occasion, the query specification unit 81 specifies a query that minimizes an expected loss by updating from among queries specified based on the expected loss representing an estimation error of the target variable by the query.

### TECHNICAL FIELD

The present invention relates to a causal relation estimating device, a causal relation estimating method, and a causal relation estimating program for estimating a causal relation.

### BACKGROUND ART

There are known a causal relation and a correlation as a relationship between two or more objects. The causal relation means that there is a cause-effect relation between two or more objects. The correlation means that there is a relevance between two or more objects.

FIG. 5 is an explanatory diagram illustrating an example of a relevance of variables. In the example illustrated in FIG. 5, the effect of each cause is represented by the direction of each arrow between variables having a causal relation. For example, since x₂ changes along with a change in variable x₁, it can be said that there is a causal relation between x₁ and x₂. On the other hand, since x₂ and x₃ change respectively along with a change in variable x₁, it can be said that there is a correlation between x₂ and x₃. However, even when either one of x₂ and x₃ is operated directly, since the other variable does not change, there is no causal relation between x₂ and x₃.

It is common practice to make a prediction in consideration of a correlation of two or more variables. However, even when a model for prediction is used, an objective variable may not be able to be controlled properly. Specifically, even when a model for measuring a correlation is used to change a correlated variable, the objective variable may not change. On the other hand, there are various problems in the world, which can be solved by grasping a causal relation and measuring the degree of impact. For example, such problems include investigating the causes of cancellation of mobile phone contracts to plan new measures, and investigating the causes of equipment failures to take measures.

As a method of estimating the causal effect correctly, statistical causal inference is known. The statistical causal inference is a technique for estimating, from data, a causal structure G between variables and a causal parameter θ. The causal structure G is a graph in which an influential relation between variables x is represented by a directed edge, and the causal parameter θ is a parameter related to the strength of the influential relation between variables x.

In the statistical causal inference, when a distribution related to variables is not assumed, the causal structure G and the causal parameter θ cannot be uniquely identified even though being able to be estimated up to its Markov equivalence class. For example, given a non-normal distribution of each variable to assume a linearity between variables, the causal structure G and the causal parameter θ can be uniquely identified.

On the other hand, the causal structure can be estimated by an intervention operation to assign a specific value to any variable. The intervention operation is so performed that intervention data on a variable when its top impact is ignored can be acquired. Use of this data enables the causal structure to be uniquely estimated. FIG. 6 is an explanatory diagram illustrating an example of an intervention operation. For example, such an intervention operation as to assign value C to variable x₂ illustrating in FIG. 6 is so performed that the causal structure can be estimated by the intervention data when the influence of variable x₁ is ignored.

Note that Non-Patent Literature 1 (NPL 1) describes an intervention method for efficiently estimating a causal structure G Further, Non-Patent Literature 2 (NPL 2) describes an intervention method for efficiently estimating a causal parameter θ.

### CITATION LIST

### Non Patent Literatures

NPL 1: Simon Tong, Daphne Koller, “Active Learning for Structure in Bayesian Networks”, IJCAI'01 Proceedings of the 17th international joint conference on Artificial intelligence, Volume 2, p. 863-869, 2001.
NPL 2: Simon Tong, Daphne Koller, “Active Learning for Parameter Estimation in Bayesian Networks”, Advances in Neural Information Processing Systems 13 (NIPS 2000), 2000.

### SUMMARY OF INVENTION

### Technical Problem

There is a need to conduct many intervention experiments in order to estimate the overall causal structure. Specifically, it is preferred that the degree of influence on a specific variable y when a variable q with a certain intervention operation possible is changed without knowing a causal structure G should be able to be grasped with as few intervention operations as possible.

NPL 1 and NPL 2 disclose intervention methods for efficiently estimating a structure or parameters for overall causes and effects. However, there may be a case where it will be enough just to be able to observe a value of a specific variable y even if the overall causal relation cannot be necessarily estimated in the actual situation.

In other words, there is a case where it is enough just to be able to observe only the influence on the specific variable y to which attention is paid, rather than the causal structure G among all variables. For example, in the example illustrated in FIG. 5, if it is enough just to be able to observe the influence on y when x₁ as an intervening variable is changed, it will be preferred to be able to make modeling without strict consideration of relationships between, x₁ to x₆ and y.

Therefore, it is an object of the present invention to provide a causal relation estimating device, a causal relation estimating method, and a causal relation estimating program, which can effectively estimate a causal relation to a variable to which attention is paid.

### Solution to Problem

The causal relation estimating device according to the present invention is a causal relation estimating device for estimating a causal relation, including: a query specification unit for specifying a query as a combination of a variable, on which an intervention operation is performed for the causal relation, and a value of the variable; an intervention data generating unit for generating intervention data including a value of a target variable, acquired with an intervention operation based on the query, and the query; and a causal relation updating unit for updating the causal relation using the generated intervention data, wherein the query specification unit specifies a query that minimizes an expected loss by updating from among queries specified based on the expected loss representing an estimation error of the target variable by the query.

The causal relation estimating method according to the present invention is a causal relation estimating method of estimating a causal relation, including: causing a computer to specify a query as a combination of a variable, on which an intervention operation is performed for the causal relation, and a value of the variable; causing the computer to generate intervention data including a value of a target variable, acquired with an intervention operation based on the query, and the query; and causing the computer to update the causal relation using the generated intervention data, wherein upon specifying a query, a query that minimizes an expected loss by updating is specified from among queries specified based on the expected loss representing an estimation error of the target variable by the query.

The causal relation estimating program according to the present invention is a causal relation estimating program applied to a computer to estimate a causal relation, the program causing the computer to execute: a query specification process of specifying a query as a combination of a variable, on which an intervention operation is performed for the causal relation, and a value of the variable; an intervention data generating process of generating intervention data including a value of a target variable, acquired with an intervention operation based on the query, and the query; and a causal relation updating process of updating the causal relation using the generated intervention data, wherein a query that minimizes an expected loss by updating is specified from among queries specified based on the expected loss representing an estimation error of the target variable by the query in the query specification process.

### Advantageous Effects of Invention

According to the present invention, a causal relation to a variable, to which attention is paid, can be estimated efficiently.

### BRIEF DESCRIPTION OF DRAWINGS

FIG. 1 It depicts a block diagram illustrating one exemplary embodiment of a causal relation estimating device according to the present invention.

FIG. 2 It depicts a flowchart illustrating an operation example of the causal relation estimating device.

FIG. 3 Its depicts a block diagram illustrating an outline of the causal relation estimating device according to the present invention.

FIG. 4 It depicts a schematic block diagram illustrating the configuration of a computer according to at least one exemplary embodiment.

FIG. 5 It depicts an explanatory diagram illustrating an example of a correlation between variables.

FIG. 6 It depicts an explanatory diagram illustrating an example of an intervention operation.

### DESCRIPTION OF EMBODIMENT

An exemplary embodiment of the present invention will be described below with reference to the accompanying drawings.

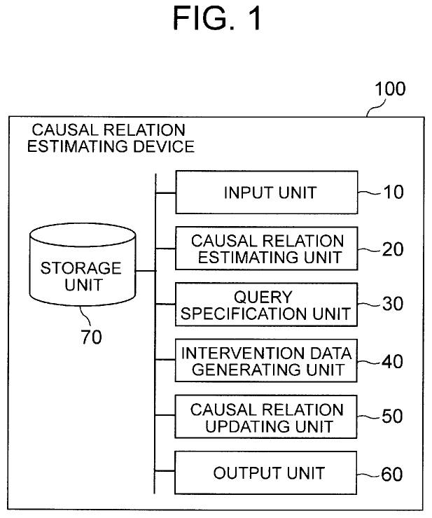

FIG. 1 is a block diagram illustrating one exemplary embodiment of a causal relation estimating device according to the present invention. A causal relation estimating device 100 of the exemplary embodiment includes an input unit 10, a causal relation estimating unit 20, a query specification unit 30, an intervention data generating unit 40, a causal relation updating unit 50, an output unit 60, and a storage unit 70.

The storage unit 70 stores data D observed based on a causal relation (hereinafter referred to as observational data). The storage unit 70 may also store a causal relation (causal model) estimated and updated by processing to be described later. The storage unit 70 is, for example, realized by a magnetic disk or the like. Note that the storage unit 70 may be provided outside of the causal relation estimating device 100.

The input unit 10 reads the observational data D stored in the storage unit 70, and inputs the read observational data D to the causal relation estimating unit 20.

The causal relation estimating unit 20 uses the input observational data D to estimate a model representing a causal relation (hereinafter referred to as a causal model). In the exemplary embodiment, the causal model is represented by a joint distribution P(θ, G) of a causal structure G and each of parameters (causal parameters) θ of the causal model.

The method of causing the causal relation estimating unit 20 to estimate the causal model is optional. For example, the causal relation estimating unit 20 may use the observational data D to do Bayesian updating of P(G) and P(θ|G) expressed in Equation 1 below in order to estimate the causal model.

$$\begin{matrix}[ Math . 1 ] & \\ P ( G \vert D ) = \frac{P ( D \vert G ) P ( G )}{P ( D )} \\ where \\ P ( D \vert G ) = {\int }_{θ} P ( D \vert θ , G ) P ( θ \vert G ) d θ & ( Equation 1 )\end{matrix}$$

As for P(θ|D, G), Equation 2 below holds.

$$\begin{matrix}[ Math . 2 ] & \\ P ( θ \vert D , G ) = \frac{P ( D \vert θ , G ) P ( θ \vert G )}{P ( D \vert G )} & ( Equation 2 )\end{matrix}$$

In Equation 2, P(D|θ, G) is a likelihood using the causal parameters θ and the causal structure G Ina binomial distribution and a beta prior distribution, each parameter of θ takes a value between 0 and 1, and the integral of θ can be expressly calculated. Note that the distributions used for estimation are not limited to the above distributions, and any other distribution may also be used. Even when any other distribution is used, an integer can be approximated by a numerical value.

In the following description, a distribution (G, θ) updated after the observational data D is observed is expressed as P(G₀, θ₀)=P(G, θ|D).

Note that, since the causal relation estimating unit 20 estimates the causal relation based on the observational data D alone, the causal structure G and the causal parameter θ cannot be uniquely identified as described above. Therefore, it can be said that the causal relation estimated by the causal relation estimating unit 20 is a causal relation having ambiguity.

The query specification unit 30 specifies a combination of a variable, on which an intervention operation is performed for the causal relation, and a value of the variable (hereinafter referred to as a query). In other words, the query specification unit 30 specifies the variable used in the intervention operation and the value of the variable.

The query specification unit 30 of the exemplary embodiment specifies a query by paying attention to the ambiguity between the intervention operation and a specific variable y (hereinafter referred to as a target variable y) (i.e., the proneness of an estimation error between the intervention operation and the target variable y) in order to be able to grasp the degree of influence on the target variable y with as few intervention operations as possible.

Processing of the query specification unit 30 will be described below in association with specific examples as appropriate. In the following specific description, X denotes a d-dimensional binomial probability vector and y denotes a binomial probability variable in X. As described above, y is the target variable, which is a variable indirectly controlled. Q denotes binomial variables in X, which are directly operable variables (i.e., variables capable of intervene) using the query.

P(X, y|θ) is a (d-dimensional) joint distribution based on the parameters θ. θ_{xi|pa(xi)} is a conditional parameter of xᵢ, where i=1, . . . , d+1. Further, P(θ_{xi|pa(xi)}|G) is a conditional beta prior distribution for xᵢ. P(θ|G) is the infinite product of P(θ_{xi|pa(xi)}|G), which is expressed in Equation 3 below.

[Math. 3]

P(θ|G)=Πᵢ₌₁^{d+1}P(θₓ_{ᵢ}_{|pa(x}_{ᵢ}₎|G) (Equation 3)

P(G) is a discrete uniform prior distribution. D is N pieces of data observed in (X, y), where D={(y¹, x¹), . . . , (y^{N}, x^{N})}.

When a causal model is updated using a query “q tilde” (hereinafter referred to as q\tilde{ }) at the time of performing a certain intervention operation and a returned target variable y, the query specification unit 30 evaluates how vague the relation between the query q\tilde{ } and the target variable y is. Specifically, the query specification unit 30 evaluates an expected loss as a result of an error in the estimation of the query q\tilde{ } and the target variable y. The definition of the expected loss is optional. For example, expectation uncertainty (uncertainty) or statistical uncertainty (entropy) is used. For example, the expected loss by the query q\tilde{ } is expressed in Equation 4 below.

$$\begin{matrix} [ Math . 4 ] & \\ Loss ( P ( \tilde{y} \vert Q := \tilde{q} ) , P ( {G}_{0} , {θ}_{0} \vert Q := q , y , x ) ) = {E}_{( {G}^{′} , {θ}^{′} ) \sim P ( {G}_{0} , {θ}_{0} \vert Q := q , y , x )} [ {\sum }_{y ∈ 0 , 1} - P ( \tilde{y} \vert Q = : \tilde{q} , {G}^{′} , {θ}^{′} ) log P ( \tilde{y} \vert Q = : \tilde{q} , {G}^{′} , {θ}^{′} ) d \tilde{y} ] & ( Equation 4 )\end{matrix}$$

In Equation 4, G₀, θ₀ represent a current causal relation, and q represents a query to be finally decided. Further, E_{a˜P(a)}[f(a)] represents an expected value of the function f(a) of a under a distribution of P(a). Note that the loss can be calculated by conducting Bayesian updating with P(G₀, θ₀|Q:=q, y, x) exemplified in the processing of the causal relation estimating unit 20.

In other words, the query specification unit 30 evaluates the ambiguity when the causal model is updated with y and X returned when the query q\tilde{ } is executed. Further, it can be said that expected values of y and X to be returned are calculated from a parameter distribution in the current causal model.

When the model expressed in Equation 4 above is evaluated, for example, the query specification unit 30 may calculate the expected loss by using a relational equation exemplified in Equation 5 below.

$$\begin{matrix} [ Math . 5 ] & \\ P ( \tilde{y} \vert Q := \hat{q} , {G}^{′} , {θ}^{′} ) ) = {\sum }_{\tilde{x}} P ( \tilde{y} \vert Q := \tilde{q} , \tilde{x} , {G}^{′} , {θ}^{′} ) P ( \tilde{x} \vert Q := \tilde{q} , {G}^{′} , {θ}^{′} ) & ( Equation 5 )\end{matrix}$$

Among queries specified based on the expected loss, the query specification unit 30 specifies such a query as to minimize the expected loss. The lager the expected loss, the more ambiguous the relation between the query and the target variable (i.e., the higher the estimation error between the query and the target variable y). Therefore, from among queries largest in expected loss, the query specification unit 30 specifies a query capable of minimizing the expected loss by updating.

For example, when the expectation uncertainty expressed in Equation 4 above is used as the expected loss, the query specification unit 30 may specify a query using Equation 6 below. In Equation 6, it is indicated that a query q is decided to be used to minimize the expected loss among queries q\tilde{ } likely to cause the largest expected loss when a certain intervention operation is performed.

$$\begin{matrix} [ Math . 6 ] & \\ q = {argmin}_{q} ExpLoss ( P ( {G}_{0} , {θ}_{0} \vert Q = : q ) ) = {E}_{( {G}_{0} , {θ}_{0} ) \sim P ( {G}_{0} , {θ}_{0} )} {E}_{( y , x ) \sim P ( y , x \vert Q := q , {G}_{0} , {θ}_{0} )} {max}_{\tilde{q}} Loss ( P ( \tilde{y} \vert Q := \tilde{q} ) , p ( {G}_{0} , {θ}_{0} \vert Q := q , y , x ) ) & ( Equation 6 )\end{matrix}$$

In the above description, a case where a max function is used to select a query largest in expected loss is exemplified. However, the method of selecting a query is not limited to the method of selecting a query largest in expected loss. For example, a query may be selected based on the average or dispersion of expected losses upon updating by the query q\tilde{ }.

As illustrated above, the query specification unit 30 specifies a query that minimizes the expected loss from among queries specified based on the expected loss representing the estimation error of the target variable by the queries. This can make the causal relation related to the target variable y clearer. When a query is specified based on the expected loss, it is more preferred that a query largest in expected loss by updating should be specified.

In other words, in the exemplary embodiment, an evaluation is performed by focusing on the target variable y, rather than by applying evaluation criteria to the overall causal relation. Since the loss described above focuses only on the relation between an intervening variable and the target variable y, the query to be specified is used to update the causal model so that the causal relation to the target variable y can be made clear with few intervention operations.

The intervention data generating unit 40 acquires a value of the target variable y with an intervention operation based on the specified query. Then, the intervention data generating unit 40 generates data (hereinafter referred to as intervention data) including the acquired target variable y and the query. For example, the intervention data generating unit 40 has only to acquire, as the value of the target variable y, the result of performing the intervention operation on the system of the causal relation to be estimated.

The causal relation updating unit 50 updates the causal relation using the generated intervention data. Specifically, the causal relation updating unit 50 updates the distribution P(G₀, θ₀) of the causal model with P(θ₀|G₀)P(G₀). In the exemplary embodiment, the update is done on condition that the target variable y is observed based on the query, i.e., that any other x is not observed.

The method for the causal relation updating unit 50 to update the causal model is optional. For example, Bayesian updating between incomplete data may be used. A specific example of the calculation method will be described below, but the update method for the causal model is not limited to the method exemplified below.

First, the causal relation updating unit 50 uses Bayes' rule to update a parameter distribution. Specifically, the causal relation updating unit 50 updates the parameter distribution based on Equation 7 exemplified below. Since the prior distribution is not updated with the intervention operation alone, P(θ₀|G₀)=P(θ₀|Q:=q, G₀) in Equation 7.

$$\begin{matrix} [ Math . 7 ] & \\ P ( {θ}_{0} \vert Q := q , y , {G}_{0} ) = {\sum }_{x} P ( {θ}_{0} \vert Q := q , x , y , {G}_{0} ) P ( x \vert Q := q , y , {G}_{0} ) = {\sum }_{x} P ( {θ}_{0} \vert Q := q , x , y , {G}_{0} ) \frac{{\int }_{{θ}_{0}} P ( x , y \vert Q := q , {θ}_{0} , {G}_{0} ) P ( {θ}_{0} \vert Q := q , {G}_{0} ) d {θ}_{0}}{{\int }_{{θ}_{0}} P ( y \vert Q := q , {θ}_{0} , {G}_{0} ) P ( {θ}_{0} \vert Q := q , {G}_{0} ) d {θ}_{0}} & ( Equation 7 )\end{matrix}$$

Next, the causal relation updating unit 50 uses Bayes' rule in the same manner to update a distribution in the graph structure G with (q, y) based on Equation 8 exemplified below.

$$\begin{matrix}[ Math . 8 ] & \\ P ( {G}_{0} \vert Q := q , y ) = \frac{P ( {G}_{0} \vert Q := q ) P ( y \vert Q := q , {G}_{0} )}{P ( y \vert Q := q )} & ( Equation 8 )\end{matrix}$$

As for P(y|Q:=q, G₀) and P(y|Q:=q) in Equation 8, Equation 9 and Equation 10 below hold, respectively.

$$\begin{matrix} [ Math . 9 ] & \\ P ( y \vert Q := q , {G}_{0} ) = {\int }_{{θ}_{0}} P ( {θ}_{0} \vert Q := q , {G}_{0} ) {\sum }_{x} P ( x \vert Q := q , {θ}_{0} , {G}_{0} ) P ( y \vert x , Q := q , {θ}_{0} , {G}_{0} ) & ( Equation 9 ) \\ P ( y \vert Q := q ) = {\sum }_{{G}_{0}} P ( {G}_{0} \vert Q := q ) P ( y \vert Q := q , {G}_{0} ) & ( Equation 10 )\end{matrix}$$

As described above, since the prior distribution is not updated with the intervention operation alone, P(G₀)=P(G₀|Q:=q) in Equation 8.

The causal relation updating unit 50 replaces the original distribution with the calculated model distribution. In other words, P(θ₁|G₁)=P(θ₀, G₀|Q:=q, y).

Then, the causal relation updating unit 50 uses any method to determine whether update processing of the causal relation is repeated or not. For example, the causal relation updating unit 50 may determine whether the number of updates exceeds a preset number of updates or not, or determine whether the expected loss is below a threshold value provided for the expected loss (uncertainty) or not. When it is determined that update processing of the causal relation is repeated (for example, when the number of updates does not exceed the preset number of updates, or when the expected loss exceeds the threshold value), the query specification unit 30, the intervention data generating unit 40, and the causal relation updating unit 50 repeat the processing described above.

The output unit 60 outputs the update results of the causal relation. For example, when the update processing is repeated t times, the output unit 60 outputs P(t, Gt) as the causal model. As is clear from the above processing, it can be said that the causal model output here is obtained by encoding the structure and parameters of the causal relation between X by focusing on the relation between Q and y.

The input unit 10, the causal relation estimating unit 20, the query specification unit 30, the intervention data generating unit 40, the causal relation updating unit 50, and the output unit 60 are implemented by a processor (for example, a CPU (Central Processing Unit), a GPU (Graphics Processing Unit), or a FPGA (field-programmable gate array)) of a computer operating according to a program (causal relation estimating program).

For example, the program may be stored in the storage unit 70, and the processor may read the program to operate as the input unit 10, the causal relation estimating unit 20, the query specification unit 30, the intervention data generating unit 40, the causal relation updating unit 50, and the output unit 60 according to the program. Further, the functions of the causal relation estimating device may be provided in the form of SaaS (Software as a Service).

The input unit 10, the causal relation estimating unit 20, the query specification unit 30, the intervention data generating unit 40, the causal relation updating unit 50, and the output unit 60 may also be implemented by dedicated hardware, respectively. Further, a part or the whole of each of components of each device may be implemented by a general-purpose or dedicated circuit (circuitry), a processor, or a combination thereof. These components may be configured by a single chip or by plural chips connected through a bus. A part or the whole of each of components of each device may also be implemented by a combination of the above-described circuit or the like and the program.

When a part or the whole of each of components of the causal relation estimating device is implemented by a plurality of information processing devices or circuits, the plurality of information processing devices or circuits may be centrally arranged, or arranged in a distributed manner. For example, the plurality of information processing devices or circuits may be realized in the form of being connected through a communication network such as a client server system and a cloud computing system.

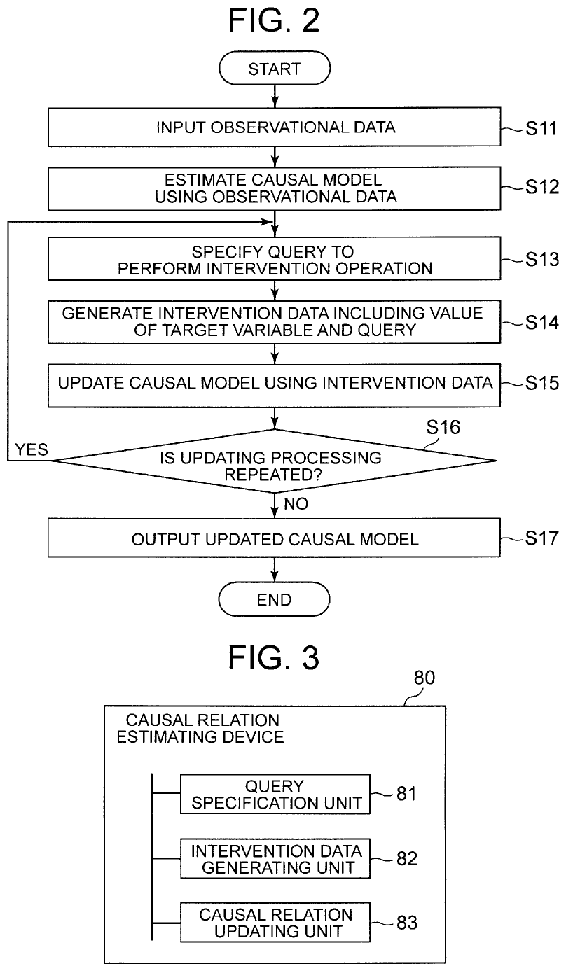

Next, the operation of the causal relation estimating device of the exemplary embodiment will be described. FIG. 2 is a flowchart illustrating an operation example of the causal relation estimating device of the exemplary embodiment. The input unit 10 inputs observational data D (step S11). The causal relation estimating unit 20 uses the input observational data D to estimate a causal model to serve as the basis (step S12).

The query specification unit 30 specifies a query to perform an intervention operation (step S13). Specifically, the query specification unit 30 specifies a query capable of minimizing the expected loss by updating from among queries specified based on the expected loss. The intervention data generating unit 40 generates intervention data including a value of the target variable, acquired by the specified query, and the query (step S14). The causal relation updating unit 50 updates the causal model using the generated intervention data (step S15).

The causal relation updating unit 50 determines whether update processing of the causal model is repeated or not (step S16). When repetition is determined (Yes in step S16), the processing in step S13 and later is repeated. On the other hand, when no repetition is determined (No in step S16), the output unit 60 outputs the updated causal model (step S17).

As described above, in the exemplary embodiment, the query specification unit 30 specifies a query as a combination of a variable, on which an intervention operation is performed for the causal relation, and a value of the variable, and the intervention data generating unit 40 generates intervention data including a value of the target variable, acquired with an intervention operation based on the query, and the query. Then, the causal relation updating unit 50 uses the generated intervention data to update the causal relation. On this occasion, the query specification unit 30 specifies a query that minimizes the expected loss by updating from among queries specified based on the expected loss representing the estimation error of the target variable by the query. This enables the causal relation to the variable, to which attention is paid, to be estimated efficiently.

In other words, in the exemplary embodiment, since uncertainty can be reduced efficiently by performing an intervention operation on the most uncertain part in the relation between the query q and the target variable y, the accuracy of modeling to represent the causal relation can be improved efficiently.

Application examples of the causal relation estimating device of the exemplary embodiment will be described below. As an example, the causal relation estimating device of the exemplary embodiment can be used for a case study on the estimation of a causal relation from each of responses in a questionnaire survey. In this case, each of the contents of the questionnaire survey and the result of the content of each response can be made to correspond to xᵢ and y, respectively. For example, as a questionnaire for mobile phone (carrier) users, it is assumed that a survey about “whether or not you will make a contract when communication speed is slow but the monthly fee is low” is conducted. In this case, the survey on the “communication speed” and the “monthly fee” can be made to correspond to x, and the presence or absence of an actual contract can be made to correspond to y, respectively. From such a survey, a causal relation (degree of influence) by changing the communication speed and/or the monthly fee (i.e., by performing an intervention operation(s)) can be estimated.

In addition, the causal relation estimating device of the exemplary embodiment can be used for a case study on the estimation of a causal relation from such a marketing research as to research the tastes of consumers in the retail field. For example, it is assumed that a marketing research for consumers on “whether to purchase a curry product if the curry taste is spicy.” In this case, the research on the “curry spiciness” can be made to correspond to x, and whether to purchase or not can be made to correspond to y. From such a research, a causal relation (degree of influence) by changing the spiciness ((i.e., by performing an intervention operation(s)) can be estimated.

In the above specific examples, a part or all of xᵢ as the contents of questions or the contents of the survey or research more generally become a candidate(s) for q. For example, it is assumed that there is a causal relation between xᵢ, and that the answer to a question content xᵢ is forcibly fixed. In this case, it is only necessary to decide on the question content and the answer thereto to make reaction y to xᵢ most uncertain in the current causal model. Then, samples (q, y) to focus on the estimation of the reaction y are acquired to update the causal model by using the samples, and this can improve the accuracy of modeling by paying attention to the reaction y.

Thus, since it is only necessary to collect information paying attention to the reaction y, not only can the cost of collecting intervention data be reduced, but also effective measures can be discovered efficiently. Further, since unnecessary processing can also be reduced on the computer used to estimate the causal relation, the processing performance of the computer can be improved.

Next, the outline of the present invention will be described. FIG. 3 is a block diagram illustrating an outline of the causal relation estimating device according to the present invention. A causal relation estimating device 80 according to the present invention is a causal relation estimating device (for example, the causal relation estimating device 100) for estimating a causal relation, which includes a query specification unit 81 (for example, the query specification unit 30) for specifying a query as a combination of a variable (for example, X), on which an intervention operation is performed for the causal relation, and a value of the variable, an intervention data generating unit 82 (for example, the intervention data generating unit 40) for generating intervention data including a value of a target variable (for example, y), acquired with an intervention operation based on the query, and the query (for example, q), and a causal relation updating unit 83 (for example, the causal relation updating unit 50) for updating the causal relation using the generated intervention data.

The query specification unit 81 specifies a query (for example, q) that minimizes the expected loss by updating from among queries (for example, query q) specified based on the expected loss (for example, expectation uncertainty or the like) representing the estimation error of the target variable by the query.

According to such a configuration, the causal relation to a variable (target variable) to which attention is paid can be estimated efficiently.

Further, the query specification unit 81 may specify a query that minimizes the expected loss by updating from among queries largest (i.e., max) in expected loss.

Further, from among candidate queries specified based on the expectation uncertainty of the target variable by the queries (for example, the expectation uncertainty illustrated in Equation 4 above), the query specification unit 81 may specify a query that minimizes the expectation uncertainty.

Further, the causal relation estimating device 80 may also include a causal relation estimating unit (for example, the causal relation estimating unit 20) for estimating a causal model (for example, P(θ, G)) as a model representing a causal relation using observational data (for example observational data D) based on the causal relation as a model representing the causal relation. Then, the causal relation updating unit 83 may update the causal model using the intervention data.

Further, when a combination of the survey item (for example, “communication speed”) and the response to the survey item (for example, “the communication speed is slow” or the like) is specified as a query, the query specification unit 81 may specify the survey item and the response to the survey item in such a manner as to make the reaction to the survey item (for example, “the presence or absence of a contract”) most uncertain in the current causal relation. Then, the intervention data generating unit 82 may generate intervention data including the reaction according to the query and the query, and the causal relation updating unit 83 may update the causal relation using the generated intervention data. According to this configuration, not only can the cost of collecting intervention data be reduced, but also effective measures can be discovered efficiently.

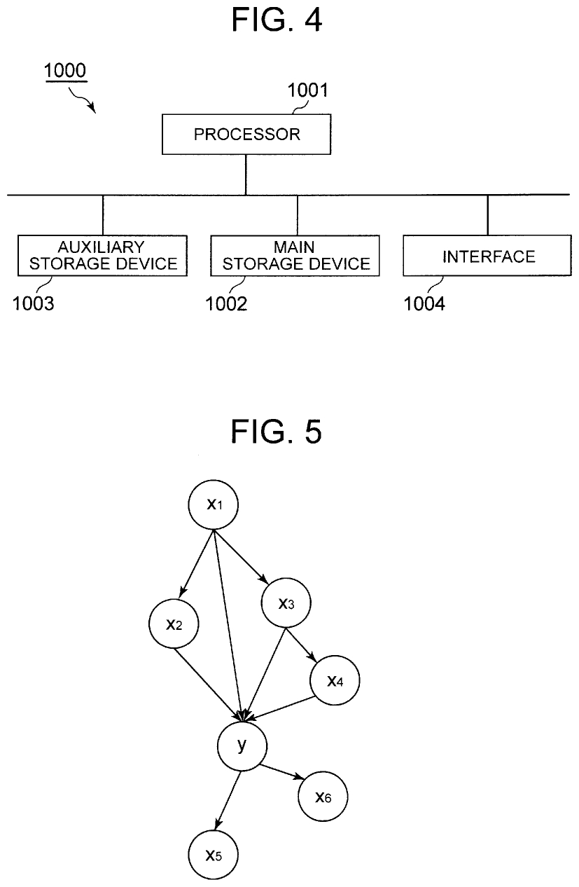

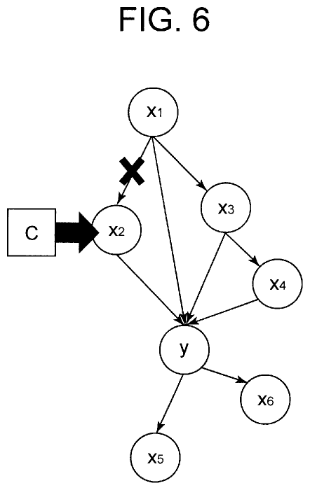

FIG. 4 is a schematic block diagram illustrating the configuration of a computer according to at least one exemplary embodiment. A computer 1000 includes a processor 1001, a main storage device 1002, an auxiliary storage device 1003, and an interface 1004.

The above-described causal relation estimating device is implemented on the computer 1000. Then, the operation of each of the above-described processing units is stored in the auxiliary storage device 1003 in the form of a program (causal relation estimating program). The processor 1001 reads the program from the auxiliary storage device 1003 and develops the program to the main storage device 1002 to execute the above processing according to the program.

In at least one exemplary embodiment, the auxiliary storage device 1003 is an example of a non-transitory tangible medium. The other examples of the non-transitory tangible medium include a magnetic disk, a magneto-optical disk, a CD-ROM (Compact Disc Read-only memory), a DVD-ROM (Read-only memory), and a semiconductor memory connected through the interface 1004. Further, when this program is distributed to the computer 1000 through a communication line, the computer 1000 may develop the distributed program to the main storage device 1002 to execute the above processing.

Further the program may be to implement some of the functions described above. Further, the program may be a so-called differential file (differential program) which implements the above-described functions in combination with another program already stored in the auxiliary storage device 1003.

### REFERENCE SIGNS LIST

10 input unit
20 causal relation estimating unit
30 query specification unit
40 intervention data generating unit
50 causal relation updating unit
60 output unit
70 storage unit
100 causal relation estimating device

1. A causal relation estimating device for estimating a causal relation, comprising a hardware processor configured to execute a software code to:
specify a query as a combination of a variable, on which an intervention operation is performed for the causal relation, and a value of the variable;
generate intervention data including a value of a target variable, acquired with an intervention operation based on the query, and the query; and
update the causal relation using the generated intervention data,
wherein the hardware processor is configured to execute a software code to specify a query that minimizes an expected loss by updating from among queries specified based on the expected loss representing an estimation error of the target variable by the query.

2. The causal relation estimating device according to claim 1, wherein the hardware processor is configured to execute a software code to specify the query that minimizes the expected loss by updating from among queries largest in expected loss.

3. The causal relation estimating device according to claim 1, wherein among candidate queries specified based on expectation uncertainty of the target variable by the queries, the hardware processor is configured to execute a software code to specify a query that minimizes the expectation uncertainty.

4. The causal relation estimating device according to claim 1, wherein the hardware processor is configured to execute a software code to:
estimate a causal model as a model representing a causal relation by using observational data based on the causal relation; and
update the causal model using the intervention data.

5. The causal relation estimating device according to claim 1, wherein the hardware processor is configured to execute a software code to:
when specifying, as a query, a combination of a survey item and a response to the survey item, specify a survey item and a response to the survey item in such a manner as to make a reaction to the survey item most uncertain in a current causal relation;
generate intervention data including a reaction according to the query, and the query; and
update the causal relation using the generated intervention data.

6. A causal relation estimating method of estimating a causal relation, comprising:
causing a computer to specify a query as a combination of a variable, on which an intervention operation is performed for the causal relation, and a value of the variable;
causing the computer to generate intervention data including a value of a target variable, acquired with an intervention operation based on the query, and the query; and
causing the computer to update the causal relation using the generated intervention data,
wherein upon specifying a query, a query that minimizes an expected loss by updating is specified from among queries specified based on the expected loss representing an estimation error of the target variable by the query.

7. The causal relation estimating method according to claim 6, wherein the query that minimizes the expected loss by updating is specified from among queries largest in expected loss.

8. A non-transitory computer readable information recording medium storing a causal relation estimating program applied to a computer to estimate a causal relation, when executed by a processor, the program performs a method for:
specifying a query as a combination of a variable, on which an intervention operation is performed for the causal relation, and a value of the variable;
generating intervention data including a value of a target variable, acquired with an intervention operation based on the query, and the query; and
updating the causal relation using the generated intervention data,
wherein a query that minimizes an expected loss by updating is specified from among queries specified based on the expected loss representing an estimation error of the target variable by the query.

9. The non-transitory computer readable information recording medium according to claim 8, wherein the query that minimizes the expected loss by updating is specified from among queries largest in expected loss.
